(19) United States
(12) Patent Application Publication
(10) Pub. No.: US 2025/0291511 A1
(43) Pub. Date: Sep. 18, 2025

(54) SYSTEM AND METHOD FOR TRAINING SPI MONITOR FOR HIGH-FREQUENCY OPERATION

(71) Applicant: Microchip Technology Incorporated, Chandler, AZ (US)

(72) Inventor: Robin Jonah Solomon, Chennai (IN)

(73) Assignee: Microchip Technology Incorporated, Chandler, AZ (US)

(21) Appl. No.: 19/077,616

(22) Filed: Mar. 12, 2025

(30) Foreign Application Priority Data
Mar. 13, 2024 (IN) 202441018021

(51) Int. Cl. G06F 3/06

(52) U.S. Cl. CPC G06F 3/0655; G06F 3/0604; G06F 3/0679

(57) ABSTRACT

Systems and methods for training a serial peripheral interface (SPI) monitor for high-frequency operation include storing a training address in memory, comparing an address accessed by an application processor (AP) with the training address, and providing a reset or interrupt signal to the AP in response to an address match. An iterative training operation is performed to train the SPI monitor for respective SPI clock delay values for an SPI clock delay that includes adjusting, for a respective SPI clock delay value, the SPI clock delay of the SPI monitor, reading data from an external SPI flash memory, comparing the read data with a reference value, and storing a pass/fail status of the read data. A selected SPI clock delay value is determined and the SPI clock delay of the SPI monitor is set to the selected SPI clock delay value.

### CROSS-REFERENCE TO RELATED APPLICATION

The present application claims priority from Indian Provisional Patent Application No. 202441018021, filed on Mar. 13, 2024, which is incorporated herein by reference in its entirety.

### TECHNICAL FIELD

The present disclosure relates generally to serial peripheral interfaces, and more specifically to a system and method for training a serial peripheral interface (SPI) monitor for high-frequency operation.

### SUMMARY

According to an aspect of one or more examples, there is provided a method to train a serial peripheral interface (SPI) monitor for high-frequencies operation. The method may include storing a training address in a non-volatile memory, comparing an address accessed by an application processor (AP) with the training address, providing a reset signal or an interrupt signal to the AP in response to an address match between the address and the training address, the providing triggering training of the SPI monitor, performing an iterative training operation to train the SPI monitor for respective SPI clock delay values of a plurality of SPI clock delay values for an SPI clock delay, the training operation including: adjusting, for a respective SPI clock delay value of the plurality of SPI clock delay values, the SPI clock delay of the SPI monitor, reading, via the AP, data from an external SPI flash memory, comparing the read data with a reference value, and storing, based on the comparing, a pass/fail status of the read data. Further, the method includes determining, based on a plurality of stored pass/fail statuses obtained from the training operation, a selected SPI clock delay value for the SPI clock delay of the SPI monitor, and setting the SPI clock delay of the SPI monitor to the selected SPI clock delay value.

The adjusting may include setting the respective SPI clock delay value in a tap control register of the SPI monitor. The reference value may be obtained from a previously stored data value and the comparing is to determine if the read data aligns with an expected outcome based on the respective SPI clock delay value of a current iteration of the training operation. The plurality of stored pass/fail statuses are stored in a static random-access memory (SRAM). The method may include repeating performance of the training operation for a different monitor by selecting a different training address that results in another address match based on the storing, the comparing, the resetting, and the triggering. The non-volatile memory may be a one-time programmable (OTP) memory. The non-volatile memory may be a flash memory. The method may include storing mode information in the non-volatile memory. The mode information may indicate a communication mode for the external SPI flash memory. The data read from the external SPI flash memory may be a predefined set of bytes of data. The read data may be obtained at a higher clock frequency than a respective clock frequency at which the reference value is obtained. The determining of the selected clock delay value may include identifying, from the stored pass/fail status, a lowest indexed SPI clock delay value that passed the comparing by matching the read data with the reference value, identifying from the stored pass/fail status, a highest indexed SPI clock delay value that passed the comparing by matching the read data with the reference value, and ascertaining an average value of the lowest indexed SPI clock delay value and the highest indexed SPI clock delay value. The selected SPI clock delay value may be the average value.

According to an aspect of one or more examples, there is provided a system to train a serial peripheral interface (SPI) monitor for high-frequencies operation. The system may include a non-volatile memory to store a training address, a comparator to compare an address accessed by an application processor (AP) with the training address, trigger circuitry to provide a reset signal or an interrupt signal to the AP in response to an address match between the address with the training address, and a training control circuitry. The training control circuitry may perform a training operation to train the SPI monitor for a plurality of SPI clock delay values for an SPI clock delay, the training operation including adjusting, for a respective SPI clock delay value of the plurality of SPI clock delay values, the SPI clock delay of the SPI monitor, reading, via the AP, data from an external SPI flash memory, comparing the read data with a reference value, and storing, based on the comparing, a pass/fail status of the read data. The training control circuitry may determine, based on a plurality of stored pass/fail statuses obtained from the training operation, a selected SPI clock delay value for the SPI clock delay of the SPI monitor and set the SPI clock delay of the SPI monitor to the selected SPI clock delay value.

The trigger circuitry may include a communication interface to send the reset signal or the interrupt signal to the AP. The communication interface may be one of a general purpose input output (GPIO), a secure inter-integrated circuit (I2C), an improved inter-integrated circuit (I3C), and an interrupt. The training circuitry may include a tap controller to set the respective SPI clock delay value in a tap control register of the SPI monitor. The training circuitry may obtain the reference value from a previously stored data value, and the comparing determines if the read data aligns with an expected outcome based on the respective SPI clock delay value of a current iteration of the training operation. The training circuitry may include an SRAM and the plurality of stored pass/fail statuses are stored to the SRAM. The system may include a selection circuitry to select a different training address for training a different SPI monitor.

According to an aspect of one or more examples, there is provided a non-transitory computer-readable storage medium storing instructions that, when executed by a processor, cause the processor to perform a method to train a serial peripheral interface (SPI) monitor for high-frequencies operation.

### BRIEF DESCRIPTION OF DRAWINGS

FIG. 1 shows a block diagram illustrating a system for training a serial peripheral interface (SPI) monitor for high-frequency operation according to one or more examples.

FIGS. 2A & 2B show a flowchart illustrating a method for training a SPI monitor for high-frequency operation according to one or more examples.

FIGS. 3A & 3B show a flowchart illustrating blocks for training a SPI monitor by resetting an application processor according to one or more examples.

FIGS. 4A & 4B show a flowchart illustrating blocks for training a SPI monitor by generating an interrupt signal to the application processor according to one or more examples.

### DETAILED DESCRIPTION OF VARIOUS EXAMPLES

Reference will now be made in detail to the following various examples, which are illustrated in the accompanying drawings, wherein like reference numerals refer to like elements throughout. The following examples may be embodied in various forms without being limited to the examples set forth herein.

In order to move towards higher serial peripheral interface (SPI) flash memory frequencies, a serial peripheral interface monitor may be trained to find a selected timing for receiving (RX) data, which may reduce server boot time. While a controller may readily adjust a clock line and initiate transfer, this approach is not applicable to a passive device such as the SPI monitor. At higher frequencies, sampling the RX data at next clock edge may not meet setup time, leading to data errors. Currently, the TAP point is determined in a validation lab. However, temperature variations and board parasitics may alter the TAP value, rendering the pre-programmed value ineffective. Therefore, shortcomings of existing processes may be addressed though a system and method for training the SPI to monitor higher frequencies.

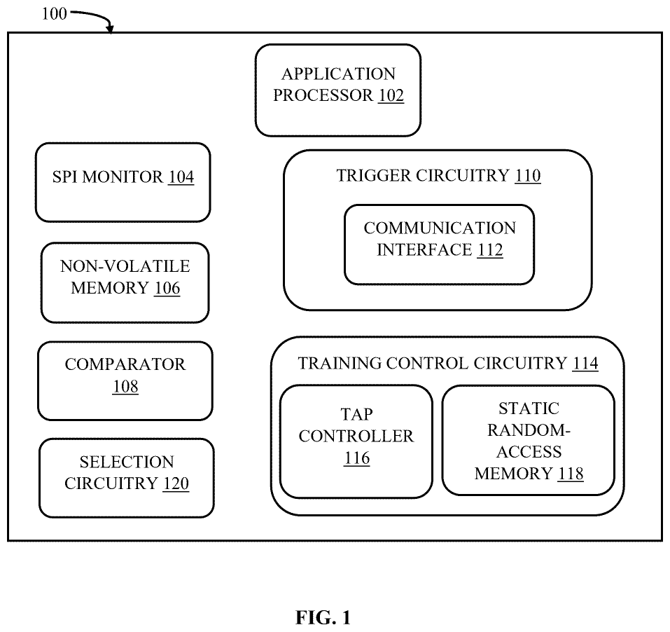

FIG. 1 shows a block diagram illustrating a system 100 for training a serial peripheral interface (SPI) monitor 104 for high-frequency operation according to one or more examples. The system 100 may include an application processor 102, the SPI monitor 104, a non-volatile memory 106, a comparator 108, a trigger circuitry 110, a training control circuitry 114, and a selection circuitry 120. The trigger circuitry 110 may include a communication interface 112 to communicate with the application processor 102. The training control circuitry 114 may include a TAP controller 116 and a static random-access memory 118.

The application processor 102 may serve as a central processing unit of the system 100, to orchestrate various aspects of the training process. The application processor 102 may access addresses and perform various operations within the system 100. The application processor 102 may initiate the training of the SPI monitor 104 by accessing an address, which may be compared with a training address stored in the non-volatile memory 106. The application processor 102 may access an SPI flash address, which corresponds to a specific location within an external SPI flash memory identified during the training process associated with the training address, to read data for calibration of the SPI monitor 104. Specifically, the application processor 102 may interact with the SPI monitor 104, read data from the external SPI flash memory, and communicate with other components through the trigger circuitry 110.

The non-volatile memory 106 may store the training address, a mode information and a firmware. In one or more examples, the non-volatile memory 106 may be a one-time programmable (OTP) memory and a flash memory. The training address for a chip select may act as a trigger to initiate the training of the SPI monitor 104. The system 100 may initiate the training for a corresponding SPI monitor connected to the chip select when the application processor 102 accesses the training address associated with the chip select. The mode information may indicate a communication mode for the external SPI flash memory. In one or more examples, the communication mode may be a single communication mode, a dual communication mode, and a quad communication mode.

The firmware may be a set of permanent instructions stored in the non-volatile memory 106. The firmware may act as an intermediary between the hardware (e.g., the application processor 102) and software (e.g., application programs). The firmware may provide specific instructions to the application processor 102 to execute for various tasks related to the training of the SPI monitor 104. The application processor 102 may fetch and interpret firmware instructions from the non-volatile memory 106 during the training of the SPI monitor 104. The firmware instructions may guide the application processor 102 to access and interpret the training address. The firmware may instruct the application processor 102 to access a specific training address stored in the non-volatile memory 106 and recognize the specific training address as a trigger to initiate the training of the SPI monitor 104. The firmware may provide instructions for the application processor 102 to interact with other components of the system 100 like the comparator 108, the trigger circuitry 110, and the training control circuitry 114. These instructions may include sending signals, retrieving data, and performing calculations. The firmware may dictate the operations involved in the training process, such as adjusting SPI clock delay, reading data from the external SPI flash memory, comparing data with reference values, storing pass/fail statuses, and identifying a selected TAP value. The application processor 102, equipped with its processing power, may execute aforementioned instructions to ensure the smooth and efficient training of the SPI monitor 104.

The SPI monitor 104 may monitor and adjust serial peripheral interface (SPI) clock delays. The SPI monitor 104 may facilitate operation of serial peripheral interface communication in high-frequency. The SPI monitor 104 may improve performance of a plurality of SPI devices connected to the system 100 by adjusting clock delays. The comparator 108 may compare the address accessed by the application processor 102 with the training address stored the non-volatile memory 106. The comparison may serve as a trigger mechanism, signaling the initiation of the training operation when an address match is detected.

The trigger circuitry 110 may initiate the training operation based on the comparison result from the comparator 108. The trigger circuitry 110 may communicate with the application processor 102, either resetting the application processor 102 or generating an interrupt signal in response to the address match, depending on a specific requirement of the training process. The trigger circuitry 110 may include the communication interface 112 to send the reset signal or the interrupt signal to the application processor 102. The communication interface may be one of a general purpose input output (GPIO), a secure inter-integrated circuit (I2C), an improved inter-integrated circuit (I3C), and an interrupt. The application processor 102 may ensure coordination between components of the system 100 during the training process.

The training control circuitry 114 may control the training process, managing the adjustment of the SPI clock delay for the SPI monitor 104 and data analysis. The training control circuitry 114 may read data from the external SPI flash memory using the application processor 102. The training control circuitry 114 may compare the read data with a reference value. The training control circuitry 114 may obtain the reference value from a previously stored data value.

The training control circuitry 114 may include a TAP controller 116 for setting a TAP value in a TAP control register, which may be used for tuning clock delays. The training control circuitry 114 may include the static random-access memory 118 to store a pass/fail status derived from the comparison of the read data and the reference value, enabling iterative refinement of clock delay settings. The training control circuitry 114 may repeat the adjusting, reading, the comparing and the storing for a plurality of SPI clock delay values. The training control circuitry 114 may determine a selected SPI clock delay based on a plurality of stored pass/fail statuses. The training control circuitry 114 may set the selected SPI clock delay for the SPI monitor 104. The selection circuitry 120 may select a different training address to train a different SPI monitor, which may provide flexibility to the system 100. The selection circuitry 120 may enhance adaptability of the system 100, allowing the system 100 to cater to diverse monitoring requirements efficiently.

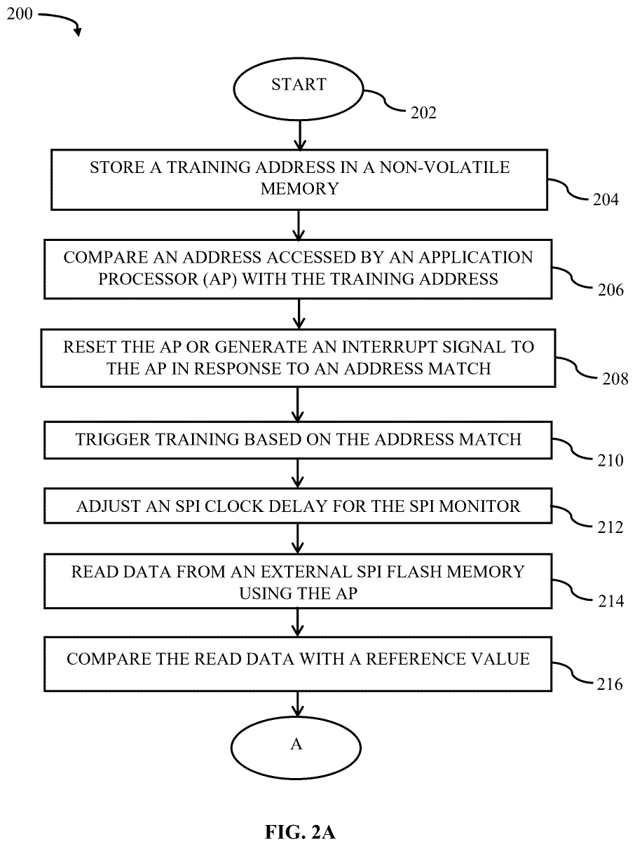

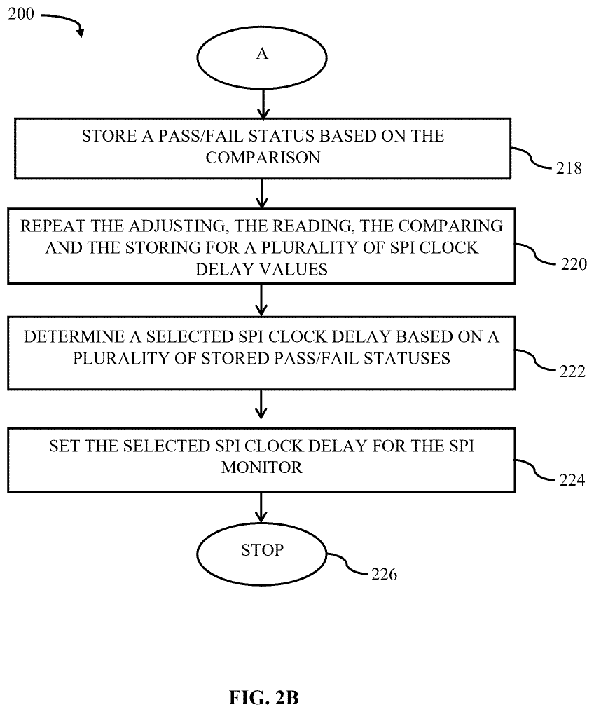

FIG. 2A and FIG. 2B in combination, illustrate a flowchart 200 of a method for training the serial peripheral interface (SPI) monitor 104 for high-frequency operation according to one or more examples. It may be noted that in order to explain the method of the flowchart 200, references will be made to the elements explained in FIG. 1.

The flowchart 200 starts at operation 202. At operation 204, the method may include storing the training address in the non-volatile memory 106. At operation 206, the method may include comparing the address accessed by the AP 102 with the training address. At operation 208, the method may include resetting the AP 102 or generating the interrupt signal to the AP 102 in response to the address match. At operation 210, the method may include triggering training based on the address match. At operation 212, the method may include adjusting the SPI clock delay for the SPI monitor 104. At operation 214, the method may include reading data from the external SPI flash memory using the AP 102. At operation 216, the method may include comparing the read data with the reference value. At operation 218, the method may include storing the pass/fail status based on the comparison. At operation 220, the method may include repeating the adjusting, the reading, the comparing and the storing for the plurality of SPI clock delay values. At operation 222, the method may include determining a selected SPI clock delay based on the plurality of stored pass/fail statuses. At operation 224, the method may include setting the selected SPI clock delay for the SPI monitor 104.

The flowchart 200 terminates at operation 226. It may be noted that the flowchart 200 is explained to have above stated process operations; however, those skilled in the art would appreciate that the flowchart 200 may have more/less number of process operations which may enable all the above stated examples of the present disclosure.

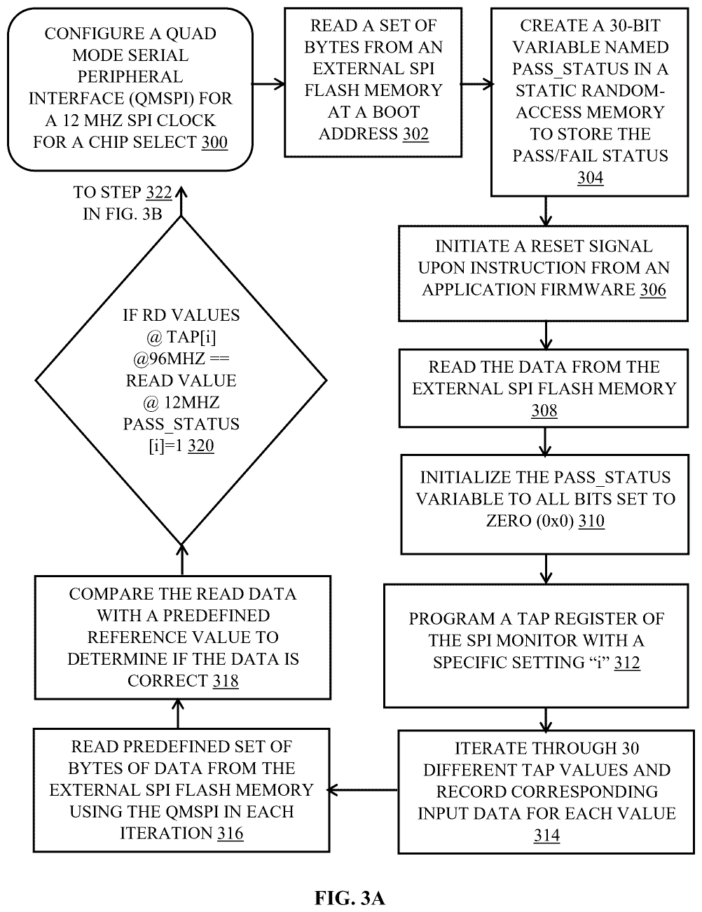

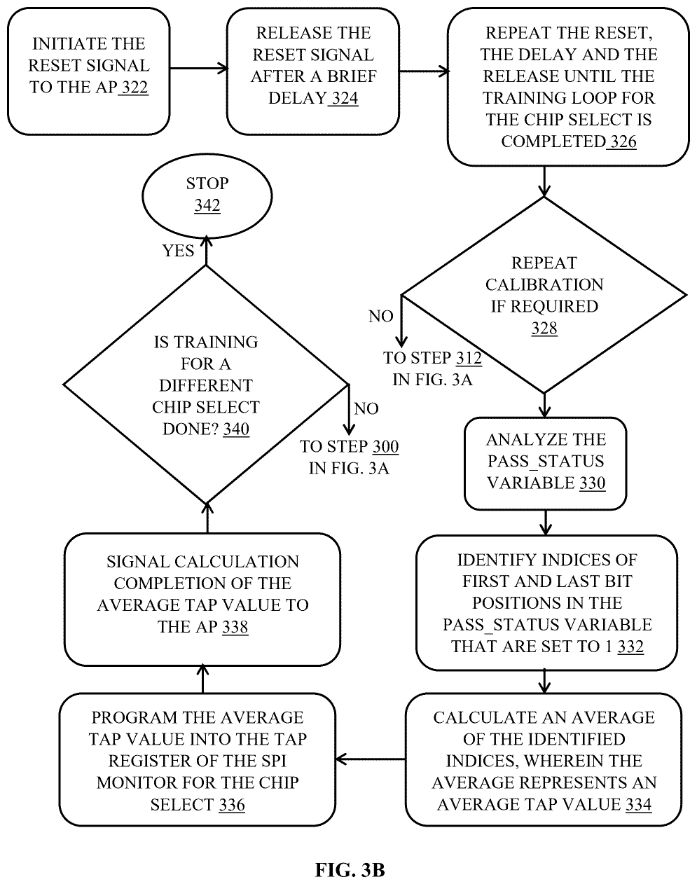

FIG. 3A and FIG. 3B in combination, illustrate a flow diagram according to one or more examples for training the SPI monitor 104 by resetting the application processor 102. At operation 300, the application firmware may configure the quad mode serial peripheral interface to operate at about 12 MHz SPI clock frequency for a chip select (e.g., CS0 #). At operation 302, the application firmware may initiate a read operation to retrieve a predetermined set of bytes from the external SPI flash memory. This operation may target a designated boot address. The retrieved data may be stored within internal memory using an existing byte hash. At operation 304, a 30-bit variable named pass_status may be created in the static random-access memory 118 to store the pass/fail status.

At operation 306, the reset signal may be initiated upon the instruction from the application firmware. At operation 308, the data may be read from the external SPI flash memory. At operation 310, the pass_status variable may be initialized to all bits set to a logic value of zero (bit Pass_Status [29:0]=0=0). At operation 312, the TAP register of the SPI monitor 104 may be programmed with a specific setting designated as “i”. The specific setting designated as “i” may represent a specific value within a pre-defined sequence of TAP values to be evaluated during the training process. At operation 314, the method may iterate through the pre-defined sequence of 30 TAP values and program the corresponding TAP register within the SPI monitor 104 for each TAP value.

At operation 316, a predefined set of bytes of data may be read from the external SPI flash memory using the quad mode serial peripheral interface in each iteration. At operation 318, the read data may be compared with a pre-defined reference value to determine if the read data aligns with the expected outcome based on the specific TAP value used during the current iteration. At operation 320, it is determined whether or not the read data obtained at about 96 MHz clock frequency using the current TAP value matches with the reference value obtained earlier at about 12 MHz clock frequency. The pass_status variable may be set to a logic value of 1 if there is a match between the data at both frequencies. At operation 322, the application firmware may initiate the reset signal to the application processor 102. At operation 324, the application firmware may introduce a brief predetermined delay before releasing the asserted reset signal to the application processor 102.

At operation 326, the reset, the delay and the release may be repeated until the training loop for the chip select is completed. At operation 328, it is determined whether or not a calibration is required. At operation 330, the pass_status variable may be analyzed, which holds the pass/fail status of each TAP value evaluated during the training process. At operation 332, two indices may be identified: the index of the first bit within the pass_status variable that is set to a logic value of 1, which signifies a lowest indexed TAP value that successfully passed the data comparison at the higher clock frequency; and the index of the last bit within the pass_status variable that is set to a logic value of 1, which signifies a highest indexed TAP value that successfully passed the data comparison at the higher clock frequency. At operation 334, an average of the identified indices may be calculated. The average may represent the average TAP value. At operation 336, the average TAP value may be programmed into the TAP register of the SPI monitor 104 for the chip select. At operation 338, calculation completion of the average TAP value may be signaled to the application processor 102. At operation 340, it is determined whether or not training for a different chip select (e.g., CS1 #) is done. If the training for the different chip select is done, at operation 342, training process is stopped. If it is determined that training for a different chip select is not done in operation 342, the method proceeds to operation 300.

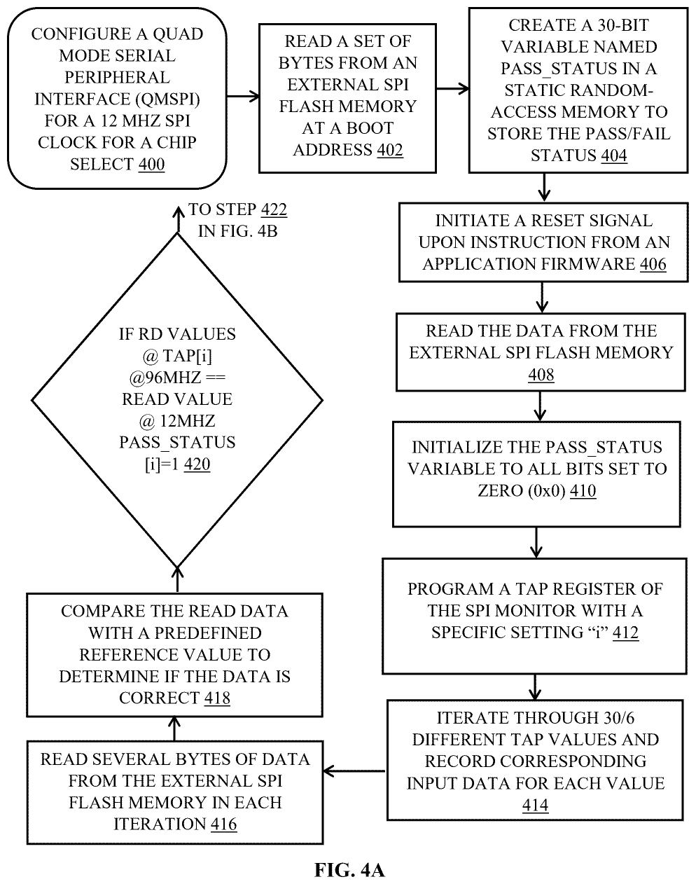

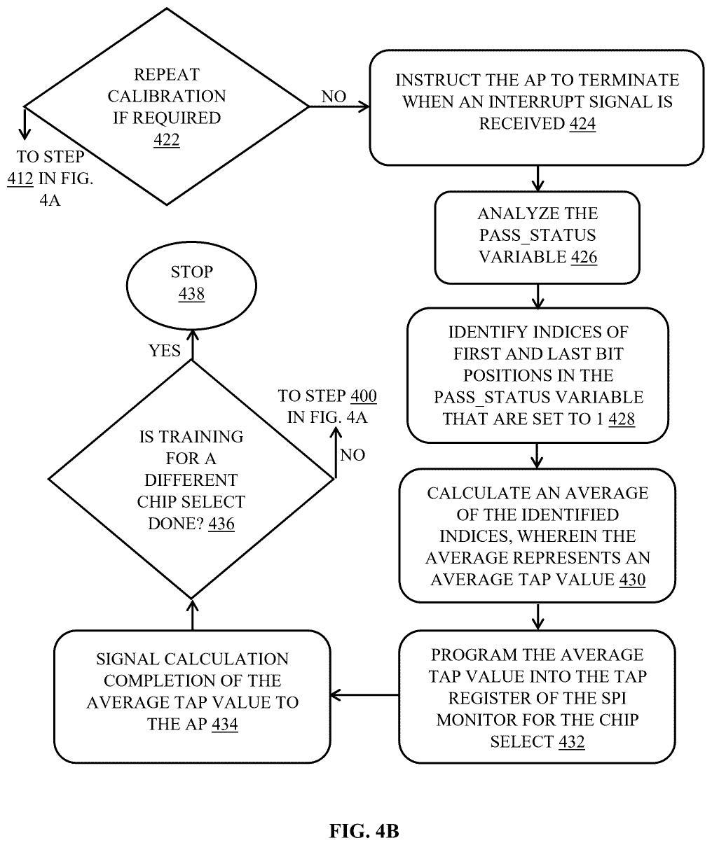

FIG. 4A and FIG. 4B in combination, illustrate a flow diagram according to one or more examples for training the SPI monitor 104 by generating the interrupt signal to the application processor 102. At operation 400, the application firmware may configure the quad mode serial peripheral interface to operate at about 12 MHz SPI clock frequency for a chip select (e.g., CS0 #). At operation 402, the application firmware may initiate a read operation to retrieve a predetermined set of bytes from the external SPI flash memory. This operation may target a designated boot address. The retrieved data may be stored within internal memory using an existing byte hash. At operation 404, a 30-bit variable named pass_status may be created in the static random-access memory 118 to the store the pass/fail status.

At operation 406, the reset signal may be initiated upon the instruction from the application firmware. At operation 408, the data may be read from the external SPI flash memory. At operation 410, the pass_status variable may be initialized to all bits set to a logic value of zero (bit Pass_Status [29:0]=0×0). At operation 412, the TAP register of the SPI monitor 104 may be programmed with a specific setting designated as “i”. The specific setting designated as “i” may represent a specific value within a pre-defined sequence of TAP values to be evaluated during the training process. At operation 414, iterate through the pre-defined sequence of 30 TAP values and program the corresponding TAP register within the SPI monitor 104 for each TAP value.

At operation 416, a predefined set of bytes of data may be read from the external SPI flash memory using the quad mode serial peripheral interface in each iteration. At operation 418, the read data may be compared with a pre-defined reference value to determine if the read data aligns with the expected outcome based on the specific TAP value used during the current iteration. At operation 420, it is determined whether or not the read data obtained at about 96 MHz clock frequency using the current TAP value matches with the reference value obtained earlier at about 12 MHz clock frequency. The pass_status variable may be set to a logic value of 1 if there is a match between the data at both frequencies. At operation 422, it is determined whether or not a calibration is required. At operation 424, the application firmware may instruct the application processor 102 to terminate when the interrupt signal is received.

At operation 426, the pass_status variable may be analyzed, which holds the pass/fail status of each TAP value evaluated during the training process. At operation 428, two indices may be identified: the index of the first bit within the pass_status variable that is set to a logic value of 1, which signifies a lowest indexed TAP value that successfully passed the data comparison at the higher clock frequency; and the index of the last bit within the pass_status variable that is set to a logic value of 1, which signifies a highest indexed TAP value that successfully passed the data comparison at the higher clock frequency. At operation 430, an average of the identified indices may be calculated. The average may represent the average TAP value. At operation 432, the average TAP value may be programmed into the TAP register of the SPI monitor 104 for the chip select. At operation 434, calculation completion of the average TAP value may be signaled to the application processor 102. At operation 436, it is determined whether or not training for a different chip select (e.g., CS1 #) is done. If the training for the different chip select is done, at operation 438, the training process is stopped. If it is determined that training for a different chip select is not done in operation 436, the method proceeds to operation 400.

Various examples have been disclosed herein, in connection with the above description and the drawings. It will be understood that it would be unduly repetitious to literally describe and illustrate each combination and subcombination of these examples. Accordingly, all examples can be combined in any way or combination, and the present specification, including the drawings, shall be construed to constitute a complete written description of all combinations and subcombinations of these examples herein, and of the manner and process of making and using them, and shall support claims to any such combination or subcombination.

It will be appreciated by persons skilled in the art that the examples described herein are not limited to what has been particularly shown and described herein above. In addition, unless mention was made above to the contrary, it should be noted that all of the accompanying drawings are not to scale. A variety of modifications and variations are possible in light of the above teachings.

What is claimed is:

1. A method for training a serial peripheral interface (SPI) monitor for high-frequency operation, the method comprising:
storing a training address in a non-volatile memory;
comparing an address accessed by an application processor (AP) with the training address;
providing a reset signal or an interrupt signal to the AP in response to an address match between the address and the training address, the providing triggering training of the SPI monitor;
performing an iterative training operation to train the SPI monitor for respective SPI clock delay values of a plurality of SPI clock delay values for an SPI clock delay, the training operation including:
adjusting, for a respective SPI clock delay value of the plurality of SPI clock delay values, the SPI clock delay of the SPI monitor;
reading, via the AP, data from an external SPI flash memory;
comparing the read data with a reference value; and
storing, based on the comparing, a pass/fail status of the read data;
determining, based on a plurality of stored pass/fail statuses obtained from the training operation, a selected SPI clock delay value for the SPI clock delay of the SPI monitor; and
setting the SPI clock delay of the SPI monitor to the selected SPI clock delay value.

2. The method of claim 1, wherein the adjusting comprises setting the respective SPI clock delay value in a tap control register of the SPI monitor.

3. The method of claim 1, wherein the reference value is obtained from a previously stored data value and the comparing determines if the read data aligns with an expected outcome based on the respective SPI clock delay value of a current iteration of the training operation.

4. The method of claim 1, wherein the plurality of stored pass/fail statuses are stored in a static random-access memory (SRAM).

5. The method of claim 1, further comprising repeating performance of the training operation for a different SPI monitor by selecting a different training address that results in another address match based on the storing, the comparing, the resetting and the triggering.

6. The method of claim 1, wherein the non-volatile memory is a one-time programmable (OTP) memory.

7. The method of claim 1, wherein the non-volatile memory is a flash memory.

8. The method of claim 1, further comprising storing mode information in the non-volatile memory, wherein the mode information indicates a communication mode for the external SPI flash memory.

9. The method of claim 1, wherein the data read from the external SPI flash memory are a predefined set of bytes of data.

10. The method of claim 1, wherein the read data is obtained at a higher clock frequency than a respective clock frequency at which the reference value is obtained.

11. The method of clam 1, wherein the determining of the selected SPI clock delay value includes:
identifying, from the stored pass/fail status, a lowest indexed SPI clock delay value that passed the comparing by matching the read data with the reference value;
identifying, from the stored pass/fail status, a highest indexed SPI clock delay value that passed the comparing by matching the read data with the reference value; and
ascertaining an average value of the lowest indexed SPI clock delay value and the highest indexed SPI clock delay value.

12. The method of claim 11, wherein the selected SPI clock delay value is the average value.

13. A system for training a serial peripheral interface (SPI) monitor for high-frequency operation, the system comprising:
a non-volatile memory to store a training address;
a comparator to compare an address accessed by an application processor (AP) with the training address;
trigger circuitry to provide a reset signal or an interrupt signal to the AP in response to an address match between the address with the training address; and
a training control circuitry to:
perform an iterative training operation to train the SPI monitor for respective SPI clock delay values of a plurality of SPI clock delay values for an SPI clock delay, the training operation including:
adjusting, for a respective SPI clock delay value of the plurality of SPI clock delay values, the SPI clock delay of the SPI monitor;
reading, via the AP, data from an external SPI flash memory;
comparing the read data with a reference value; and
storing, based on the comparing, a pass/fail status of the read data;
determine, based on a plurality of stored pass/fail statuses obtained from the training operation, a selected SPI clock delay value for the SPI clock delay of the SPI monitor; and
set the SPI clock delay of the SPI monitor to the selected SPI clock delay value.

14. The system of claim 13, wherein the trigger circuitry comprises a communication interface to send the reset signal or the interrupt signal to the AP.

15. The system of claim 14, wherein the communication interface is one of a general purpose input output (GPIO), a secure inter-integrated circuit (I2C), an improved inter-integrated circuit (I3C), and an interrupt.

16. The system of claim 13, wherein the training circuitry comprises a tap controller to set the respective SPI clock delay value in a tap control register of the SPI monitor.

17. The system of claim 13, wherein the training circuitry obtains the reference value from a previously stored data value, and the comparing determines if the read data aligns with an expected outcome based on the respective SPI clock delay value of a current iteration of the training operation.

18. The system of claim 13, wherein the training circuitry comprises an SRAM, and the plurality of stored pass/fail statuses are stored to the SRAM.

19. The system of claim 13, further comprises a selection circuitry to select a different training address for training a different SPI monitor.

20. A non-transitory computer-readable storage medium storing instructions that, when executed by a processor, cause the processor to:
store a training address in a non-volatile memory;
compare an address accessed by an application processor (AP) with the training address;
provide a reset signal or an interrupt signal to the AP in response to an address match between the address and the training address, the providing triggering training of the SPI monitor;
perform an iterative training operation to train the SPI monitor for respective SPI clock delay values of a plurality of SPI clock delay values for an SPI clock delay, the training operation including:
adjusting, for a respective SPI clock delay value of the plurality of SPI clock delay values, the SPI clock delay of the SPI monitor;
reading, via the AP, data from an external SPI flash memory;
comparing the read data with a reference value; and
storing, based on the comparing, a pass/fail status of the read data;
determine, based on a plurality of stored pass/fail statuses obtained from the training operation, a selected SPI clock delay value for the SPI clock delay of the SPI monitor; and
set the SPI clock delay of the SPI monitor to the selected SPI clock delay value.
